(19) United States
(12) Patent Application Publication
(10) Pub. No.: US 2015/0149756 A1
(43) Pub. Date: May 28, 2015

(54) SYSTEM AND METHOD FOR SETTING UP A BOOTABLE STORAGE DEVICE USING IMAGE

(71) Applicants: INVENTEC (PUDONG) TECHNOLOGY CORPORATION, Shanghai (CN); INVENTEC CORPORTION, Taipei (TW)

(72) Inventor: Yue GE, Shanghai (CN)

(21) Appl. No.: 14/319,347

(22) Filed: Jun. 30, 2014

(30) Foreign Application Priority Data
Nov. 28, 2013 (CN) 201310625955.1

(51) Int. Cl. G06F 9/44

(52) U.S. Cl. CPC G06F 9/4416
USPC 713/2

(57) ABSTRACT

A system and method for setting up a bootable storage device using an image are disclosed, a booting image supporting the network file system service is built up in an OS installed into a temporary device, the booting image and the kernel of the OS are copied to a pre-boot execution environment (PXE) root directory of the target device, and a bootable storage device is built up on the target device with the PXE root directory of the target device after the target device is booted, afterwards, whereby solving the issue encountered in the prior art, and achieving the technical efficacy of installing software in the OS booted through the network.

### BACKGROUND OF THE RELATED ART

1. Technical Field

A system and method for building up a bootable storage device using an image, and particularly a system and method for building up a bootable storage device by guiding a target device to use a network file system service.

2. Related Art

At present, there are two main booting fashions for an operating system (OS) on a computer. One is booting the computer by arranging a particular booting program to guide a kernel to execute and load an image of the OS on an external storage device, such as a USB storage device. The other is guiding the kernel to execute and load in the image of the OS by using a pre-boot execution environment (PXE) service.

However, in the case of using the external storage device, since the image of the OS has been stored in the external storage device previously, it may not be install new software as desired under the OS loaded in by such way. If one needs to install new software under such OS, it requires producing an image containing the new software previously.

For the case of using the PXE in booting the computer, since the PXE may guide the kernel to download the image of the OS through the network, the file size of the image stored on the network is limited by a network storage space and a network bandwidth. As such, the OS loaded in by this manner might not contain all the required components for the OS, resulting in absence of some functions and tools.

In view of the above, it may be known that there is long an issue where the OS might not be complete and the software install might not be free by using the booting manner of an external device. Therefore, it is quite a need to set forth an associated technology to solve this issue in the prior art.

### SUMMARY

In view of the issue in the prior art where the operating system (OS) might not be complete and the software install might not be free by using the booting manner of an external device, the present invention discloses a system and method for building up a bootable storage device by using an image.

According to the present invention, the system for building up a bootable storage device by using an image comprises an environment set-up module, setting a root path of a network file system (NFS) service as being writable; an OS install module, installing an OS into a temporary device; a booting process set-up module, building up a booting image supporting the NFS service on the OS and a pre-boot execution environment (PXE) service; a booting file set-up module, mounting the root path of the NFS service on the OS, copying system files of the OS to the root path of the NFS service, and copying the booting image and a kernel of the OS to a PXE root directory of a target device, wherein the kernel supports the PXE service; and a booting device producing module, building up the bootable storage device with the PXE root directory.

According to the present invention, the method of building up a bootable storage device by using an image comprises steps of providing a NFS service and a PXE service; setting a root path of the NFS service as being writable; installing an OS on a temporary device; mounting the root path of the NFS on the OS; copying system files of the OS to the root path of the NFS service; building up a booting image supporting the NFS service on the OS and the PXE service; copying the booting image and a kernel of the OS to a PXE root directory of a target device, wherein the kernel supports the PXE service; building up a bootable storage device with the PXE root directory.

The system and method of the present invention has the difference that the booting image supporting the NFS service is built up in the OS installed into the temporary device, the booting image and the kernel of the OS are copied to the PXE root directory of the target device, and the bootable storage device is built up on the target device with the PXE root directory after the target device is booted, whereby solving the issue encountered in the prior art, and achieving the technical efficacy of installing software in the OS activated through the network.

### BRIEF DESCRIPTION OF THE DRAWINGS

The invention will become more fully understood from the detailed description given herein below illustration only, and thus is not limitative of the present invention, and wherein:

FIG. 1 is a systematic architecture diagram of a system for setting up a bootable storage device using the image according to the present invention;

FIG. 2A is a flowchart of a method for building up the bootable storage device using the image according to the present invention;

FIG. 2B is a flowchart of a method for building up a booting image supporting a network file system service according to the present invention; and

FIG. 2C is a detailed flowchart of the method for building up the bootable storage device according to the present invention.

### DETAILED DESCRIPTION

The present invention will be apparent from the following detailed description, which proceeds with reference to the accompanying drawings, wherein the same references relate to the same elements.

The present invention may produce an image for an operating system (OS). When a target device is booted by using the image produced by the present invention, it may load in system elements required by the OS through a network file system (NFS) service.

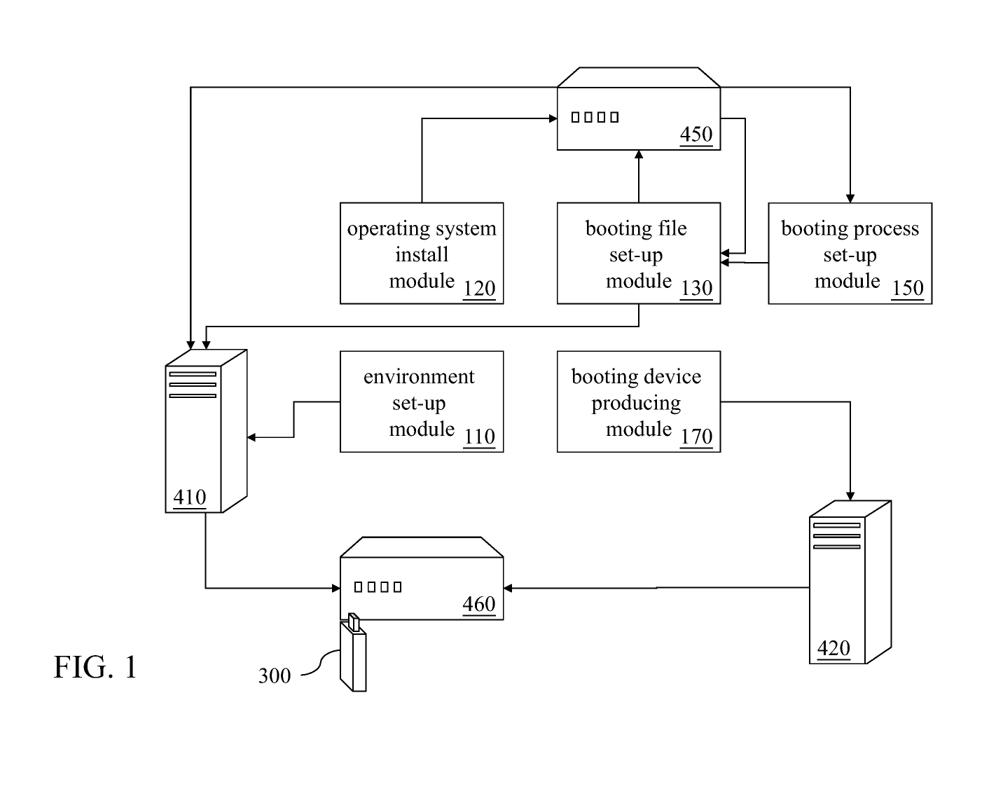

Referring to FIG. 1, which is a systematic architecture diagram of a system for setting up a bootable storage device using an image according to the present invention. As shown, the system of the present invention comprises an environment set module 110, an OS install module 120, a booting file set-up module 130, a booting process set-up module 150, and a booting device producing module 170.

The environment set module 110 sets up a root path of the NFS service as being writable. Generally, the NFS service is provided by a NFS server 410, without limiting the present invention. In some embodiments, the server providing the NFS service may provide other services simultaneously, such as pre-boot execution environment (PXE) service.

The OS install module 120 is used to install an OS in a temporary device 450 for producing the image of the OS. The temporary device 450 may be a physical device or a virtual apparatus, without limiting the present invention.

The booting file set-up module 130 mounts the root path of the NFS service on the OS installed in the temporary device 450 by the OS install module 120, so that the OS on the temporary device 450 generates a virtual disk drive. By means of the virtual disk drive, the OS on the temporary device 450 may access files under the root path of the NFS service.

In some embodiments, the booting file set-up module 130 may need to modify mounting information in the OS operated on the temporary device 450, so that the OS may exactly mount the root path of the NFS service set as writable by the environment set module 110.

The booting file set-up module 130 also executes one or more copy instructions in the OS operated on the temporary device 450 for copying the system files of the OS operated on the temporary device 450 to the virtual disk drive generated by the OS, i.e. the system files of the OS are copied to the root path of the NFS service through the network.

The booting file set-up module 130 also copy the booting image generated by the booting process set-up module 150 and a kernel of the OS operated on the temporary device 450 to a PXE root directory of a target device.

The booting process set-up module 150 builds up a booting image supporting the NFS service on the OS operated on the temporary device 450. Generally, the booting process set-up module 150 may edit one or more booting configurations of the OS operated on the temporary device 450, and execute a program corresponding to the edited booting configuration in the OS. As such, when the program is executed in the OS, the program may produce the booting image according to the corresponding booting configuration. However, the booting process set-up module 150 is not limited to this example.

The booting device producing module 170 builds up a bootable storage device 300 on the target device 460 after the target device 460 is booted. Generally, the target device 460 is booted with the booting image and the kernel copied to the PXE root directory of the target device 460 by the booting file set-up module 130. The storage device 300 may use the NFS service to load in the system elements with the PXE root directory of the target device 460 in the course of booting.

Typically, the booting device producing module 170 may execute a formatting instruction to format the storage device 300 on the target device 460, execute a program for recording booting information and writing the booting information to the storage device 300, and amend the booting information copied to the storage device 300, so as to builds up the storage device 300 as bootable. However, the manner of the booting device producing module 170 producing the bootable storage device 300 is not limited to this example.

The booting device producing module 170 may amends the PXE configuration stored in the PXE service, so that the PXE configuration may truly record that the system elements needed in the process of booting may be downloaded through the NFS service.

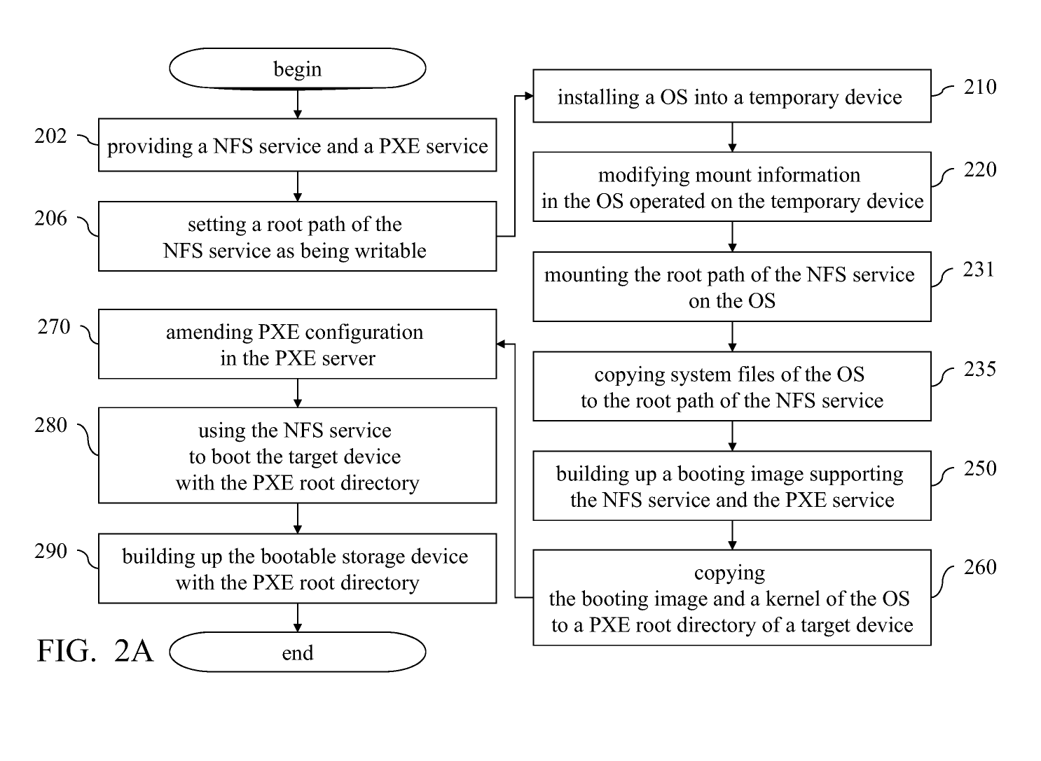

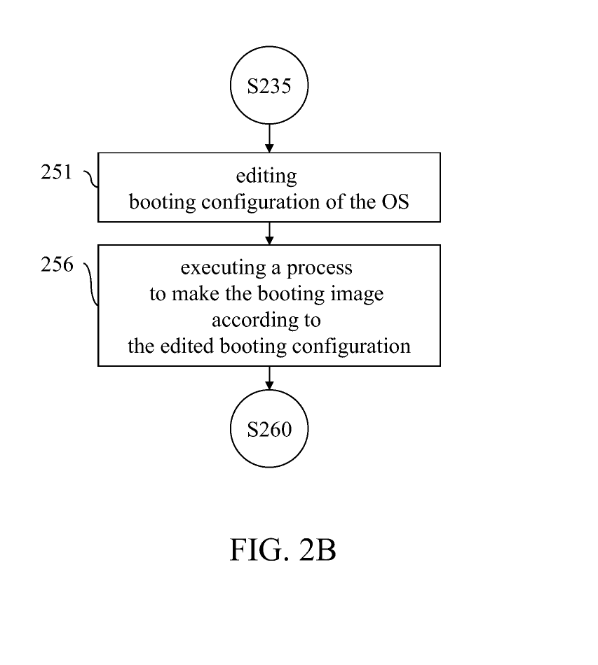

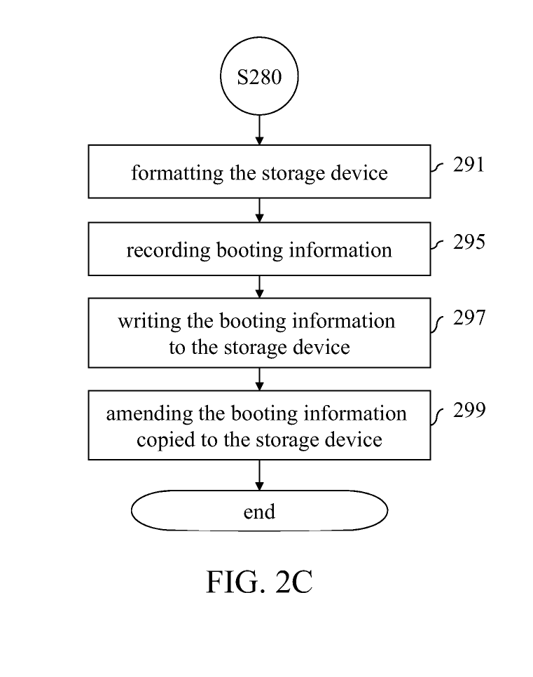

Thereafter, an embodiment is set forth to explain how the system and method of the present invention are operated, with reference to FIG. 2A, in which a method for setting up a bootable storage device by using an image according to the present invention is illustrated. In this embodiment, assume the OS is Ubuntu, without limiting the present invention.

When a user requires building up a storage device capable of connecting to the NFS server through network and downloading system elements for booting, the user has to provide the NFS service and the PXE service (S202). In this embodiment, the user may build up a server capable of providing the NFS service and the PXE service. Alternatively, the currently existing NFS server 410 and the currently existing PXE server 420 may also be used by the user, so that the two services mentioned may be provided.

After the step S202 of providing the NFS service and the PXE service, the environment set-up module 110 may set a root path of the NFS service as being writable (S206).

Thereafter, the OS install module 120 may install the OS into the temporary device 450 (S210). In this embodiment, the OS install module 120 may use an install compact disk (CD) of the Ubuntu OS, or an image of the install CD to install the Ubuntu OS into the temporary device 450.

In real implementation, the OS install module 120 installs the OS into the temporary device 450 (S210) and provides the NFS service and the PXE service (S202), and the environment setting module 110 sets the root path of the NFS service as being writable (S206), without any fixed order.

After the OS install module 120 installs the OS on the temporary device 450 (S210), the booting file set-up module 130 may mount the root path of the NFS service in the OS operated on the temporary device 450 (S231), and copy the system files of the OS operated on the temporary device 450 to the root path of the NFS service mounted by the OS (S235). In this embodiment, assume the booting file set-up module 130 may mount the root path of NFS service and the other paths according to a content (mounting information) recorded in a “fstab” file stored by the OS operated on the temporary device 450. The content comprises as follows:

# /etc/fstab: static file system information.
#

| #<file system> | <mount point> | <type> | <options> | <dump> | <pass> |
|---|---|---|---|---|---|
| proc | /proc | proc | defaults | 0 | 0 |
| /dev/nfs | / | nfs | defaults | 1 | 1 |
| none | /tmp | tmpfs | defaults | 0 | 0 |
| none | /var/run | tmpfs | defaults | 0 | 0 |
| none | /var/lock | tmpfs | defaults | 0 | 0 |
| none | /var/tmp | tmpfs | defaults | 0 | 0 |

Then, the booting file set-up module 130 may copy the system files of the OS to the root path of the NFS service mounted by the OS.

Therefore, if the root path of the NFS service required to be mounted is not recorded on the mounting information, the booting file set-up module 130 needs to modify the mount information (the content of the file “fstab”) in the OS operated on the temporary device 450 (S220), so that the mounting information may record the root path of the NFS service. Subsequently, the temporary device 450 may mount the root path of the NFS service and other paths according to the mounting information (S231).

After the system files of the OS operated on the temporary device 450 are copied to the root path of the NFS service mounted by the OS (S235), the booting process set-up module 150 may build up a booting image supporting the NFS server (S250). In this embodiment, assume the process goes as what is shown in FIG. 2B, the booting process set-up module 150 may first edit a booting configuration in the OS operated on the temporary device 450 (S251). For example, the /etc/initramfs-tools/initramfs.conf is amended into the following content:

# BOOT: [ local | nfs ]
#
# local - Boot off of local media (harddrive, USB stick).
#
# nfs - Boot using an NFS drive as the root of the drive.
#
BOOT=nfs
#
# MODULES: [ most | netboot | dep | list ]
MODULES=netboot

Thereafter, the booting process set-up module 150 may execute a program in the OS, to produce the booting image according to the edited booting configuration (S256). For example, the booting process set-up module 150 executes an instruction of “minitramfs/home/YF/initrd.img-2.6.20-16-generic” for producing the booting image “initrd.img” supporting the NFS service provided by the NFS server, in which “minitramfs” is the file name of executed program and “/home/YF/initrd.img-2.6.20-16-generic” is a parameter required by the executed program for producing the booting image “initrd.img”.

After the booting process set-up module 150 builds up the booting image supporting the NFS server in the OS operated on the temporary device 450 (S250), the booting file set-up module 130 may copy the booting image built by the booting process set-up module 150 and the kernel of the OS operated on the temporary device 450 to the PXE root directory of a target device 460 in the PXE server providing the PXE service (S260), whereby the target device 460 may be booted through the network. In this embodiment, assume the booting file set-up module 130 may compress the kernel of the OS to a file “vmlinuz”, and copy the booting image “initrd.img” and the file “vmlinuz” to the PXE root directory of the target device 460.

To enable the target device 460 to be booted through the network smoothly, the PXE configuration of the PXE service must have the following content:

label Ubuntu NFS
kernel vmlinuz
append initrd=initrd.img-xxx boot=nfs root=/dev/nfs nfsroot=[NFS
Server IP]:[NFS Root Path] ip=dhcp rw

In the case that the PXE configuration does not have the above content, the PXE configuration in the PXE server may be amended to have those content by the booting file set-up module 130 (S270).

After the booting file set-up module 130 copy the booting image and the kernel of the OS operated on the temporary device 450 to the PXE root directory of the target device 460 (S260), if the target device 460 is not booted and the PXE configuration in the PXE service includes a content capable of enabling the target device 460 smoothly to boot through the network, the booting device producing module 170 may use the NFS service to boot the target device 460. When the target device 460 is booting, the target device 460 may boot with the booting image stored in the PXE root directory of the target device 460 and loading in the system elements according to the kernel stored in the PXE root directory of the target device 460 and the system files stored in the root path of the NFS service (S280), so that the OS may commence to operate on the target device 460.

After the OS commences to run on the target device 460, the booting device producing module 170 may build up the bootable storage device 300 on the target device 460 (S290).

In this embodiment, assume the storage device 300 is a USB Flash drive, and the target device 460 and the storage device 300 are connected together, the booting device producing module 170 may run as what shown in FIG. 2C. First, the storage device 300 is formatted by the booting device producing module 170 (S291), such as being formatted the storage format of the storage device 300 into the FAT32 format. Thereafter, a program is executed by the booting device producing module 170 for recording booting information from the OS operated on the target device 460 (S295) and writing the booting information to the storage device 300 (S297), such as the instruction of “syslinux-maf-d/syslinux u:” is executed by the booting device producing module 170, where “Syslinux” is the file name of the executed program and “-maf-d/syslinux u:” are parameters for recording booting information and writing the booting information to the storage device 300.

After the program executed by the booting device producing module 170 records the booting information (S295) and writes the booting information to the storage device 300 (S297), the booting device producing module 170 may continue to amend the booting information copied to the storage device 300 (S299). For example, the booting information is amended into the following content.

label Ubuntu
menu label Ubuntu USB
kernel /ubuntu/vmlinuz
append initrd=/ubuntu/initrd.img-xxx

After the booting producing module 170 builds up the bootable storage device 300 (S290), the user may acquire the storage device 300 capable of booting other devices. And, when the other devices use the storage device 300 to boot, the other device may load in the system elements required by the OS by connecting to the NFS service through the network, similarly to the booting process of the target device 460.

In view of the above, the system and method of the present invention has the difference as compared to the prior art that the booting image supporting the NFS service is built up in the OS installed in the temporary device, the booting image and the kernel of the installed OS are copied to the PXE root directory of the target device, and the bootable storage device is built up on the target device with the booting image and the kernel stored in the PXE root directory of the target device after the target device is booted, afterwards, whereby solving the issue encountered in the prior art where the external device booting manner may not consider a complete OS and a free software install, and achieving the technical efficacy of installing software in the OS booted through the network.

Furthermore, the method for building up a bootable storage device by using an image according to the present invention may be implemented in hardware, software or combination thereof. Alternatively, the method may also be implemented in a single unit or separate computer systems connected with one another with discrete components arranged therein.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A method of building up a bootable storage device by using an image, comprising steps of:
providing a network file system (NFS) service and a pre-boot execution environment (PXE) service;
setting a root path of the NFS service as being writable;
installing an OS into a temporary device;
mounting the root path on the OS;
copying system files of the OS to the root path;
building up a booting image supporting the NFS service on the OS and the PXE service;
copying the booting image and a kernel of the OS to PXE root directory of a target device, wherein the kernel supports the PXE service; and
building up a bootable storage device with the PXE root directory.

2. The method as claimed in claim 1, further comprising a step of modifying mounting information of the root path prior to the step of installing the OS into the temporary device.

3. The method as claimed in claim 1, the step of building up a booting image supporting the NFS service on the OS and the PXE service further comprising steps of editing at least one booting configuration of the OS and executing a process to make the booting image according to the edited booting configuration.

4. The method as claimed in claim 1, further comprising a step of amending a PXE configuration in the PXE service prior to the step of building up the bootable storage device with the PXE root directory.

5. The method as claimed in claim 1, further comprising a step of using the NFS service to boot the target device with the booting image and the kernel in the PXE root directory prior to the step of building up the bootable storage device with the PXE root directory.

6. The method as claimed in claim 1, the step of building up the bootable storage device with the PXE root directory further comprising steps of formatting the storage device connected with the target device, executing a program for recording booting information and writing the booting information to the storage device, and amending the booting information copied to the storage device.

7. A system of building up a bootable storage device by using an image, comprising:
an environment set-up module, setting a root path of a NFS service as being writable;
an OS install module, installing an OS into a temporary device;
a booting process set-up module, building up a booting image that supporting the NFS service on the OS and a PXE service;
a booting file set-up module, mounting the root path on the OS, copying system files of the OS to the root path, and copying the booting image and a kernel of the OS to a PXE root directory of a target device, wherein the kernel supports the PXE service; and
a booting device producing module, building up the bootable storage device with the PXE root directory.

8. The system as claimed in claim 7, wherein the booting file set-up module further modifies mounting information of the root path.

9. The system as claimed in claim 7, wherein the booting process set-up module further edits at least one booting configuration of the OS, and executes a program to make the booting image according with the edited booting configuration.

10. The system as claimed in claim 7, wherein the booting files set-up module further amends a PXE configuration in the PXE service.

11. The method as claimed in claim 7, the booting device producing module further uses the NFS service to boot the target device with the booting image and the kernel in the PXE root directory.

12. The system as claimed in claim 7, wherein the booting device producing module builds up the storage device by formatting the storage device connected with the target device, executing a program for recording booting information and writing the booting information to the storage device, and amending the booting information copied to the storage device.
